(19) United States
(12) Patent Application Publication
(10) Pub. No.: US 2018/0309627 A1
(43) Pub. Date: Oct. 25, 2018

(54) ON-DEMAND MONITORING

(71) Applicant: Abode Systems, Inc., Palo Alto, CA (US)

(72) Inventors: Alfred Yarbrough, Lake Worth, FL (US); Christopher Brian Carney, Saratoga, CA (US); Brent Franks, Fort Myers, FL (US); Andrew Fouse, Alexandria, PA (US)

(73) Assignee: Abode Systems, Inc., Palo Alto, CA (US)

(21) Appl. No.: 15/496,769

(22) Filed: Apr. 25, 2017

(51) Int. Cl. H04L 12/24; G08B 29/18

(52) U.S. Cl. CPC H04L 41/0813; G08B 29/18; H04L 41/084

(57) ABSTRACT

A computer program configured as a server includes a first interface for communication between the network node and a computer device, a second interface for communication between the network node and the monitoring service, a third interface for communication between the network node and the home gateway, and a database to store configuration data of the home gateway. The server includes logic to maintain the configuration data in the database via communications using the third interface which include messages identifying sensing devices connected to the home gateway. The server includes logic to receive an activation request from the computing device via the first interface, and in response to the activation request, execute a protocol via the second interface to create a user record using the configuration data. The server includes logic to verify a connection between the home gateway and the user record via the third interface.

### BACKGROUND

### Field of the Invention

The present invention relates to home automation, and particularly to home security systems.

### Description of Related Art

A home security system can include security hardware in place at a home, such as sensing devices for windows, doors, locks, and lighting, alarms, smoke and motion detectors, and security cameras. Traditionally, a security company needs to send a human technician to a user's home to install a home security system, so the system can be properly set up and provisioned for connection to, and monitoring by, a monitoring service.

However, a home security system that requires installation and provisioning by a human technician can be prone to human errors in installation, cause inconvenience for the user, and add to the overall cost of a home security system. Furthermore, a home security system that requires installation by a human technician may further require a human technician to be dispatched to a user's home after the installation, if any sensing device needs to be added or deleted.

When provisioning a home security system for monitoring by a monitoring service, it is critical that the monitoring service have accurate and up to date information about the configuration of the home security system. As the configurations can change as a do it yourself home owner adds and removes components and sensors, this presents a technical problem that has required human technicians to resolve.

It is desirable to provide a home security system that can be provisioned on demand for monitoring by a monitoring service without the need to dispatch a human technician to a user's home.

### SUMMARY

The present technology is directed to solving the problems associated with provisioning a monitoring service that includes providing a server for execution at a network node for an alarm system. A server includes logic to maintain configuration data of a home gateway in a database, logic to execute an on-demand monitoring activation sequence, and logic to execute an on-demand monitoring deactivation sequence, via interfaces for communication between the network node and a computer device, a monitoring center and a home gateway.

A server is described which automatically provisions a monitoring service on demand from a user, without requiring a technician. The server can be configured for execution at a network node for communication with user devices, alarm systems and monitoring services and to coordinate the provisioning procedures among the actors. The alarm system includes a network node including a home gateway with sensing devices connected to the home gateway, and the monitoring service includes a network node including a communications channel for communication with the home gateway. The user device can comprise a smart phone or tablet, personal computer or the like, acting as a network node for communication between the user and the server. Once an activation request for a monitoring service is received by the server, an activation sequence is automated with the server to activate the monitoring service, without the need to dispatch a human technician to a user's home to set up the alarm system. The automation sequence includes creating a user record at a monitoring center, and setting up and verifying a connection between the home gateway and the monitoring center. Activation of a monitoring service as described herein does not need a human technician's or a user's involvement in or awareness of the activation sequence.

The server includes a first interface for communication between the network node and a computer device, a second interface for communication between the network node and the monitoring service, a third interface for communication between the network node and the home gateway, and a database to store configuration data of the home gateway, including device configuration data indicating the sensing devices connected to the home gateway.

Using technology described herein, a monitoring service can be activated any time from a web browser or from a mobile app on a computer device as long as the computer device has internet access, or other electronic communication with the server.

The server includes logic to maintain the configuration data in the database via communications using the third interface with the home gateway which include messages identifying sensing devices connected to the home gateway.

The server includes logic to receive an activation request from the computing device via the first interface, and in response to the activation request, execute a protocol via the second interface with the monitoring service to create a user record using the configuration data of the home gateway stored in the database. The logic to execute a protocol via the second interface with the monitoring service is initiated asynchronously with the logic to maintain the configuration data. The response to the activation request, and the receipt of activation request, are asynchronous because the activation request is provided by communication via the first interface that is initiated by a user whenever convenient to the user, while the logic to maintain the configuration data is invoked by changes in the configuration at the gateway and utilizes the second interface at times that are not initiated by the user via the first interface.

The server includes logic to receive input data indicating a request for a monitoring plan via the first interface with the computer device, and logic to set up an expiration time for the monitoring service according to the monitoring plan.

The server includes logic to verify a connection between the home gateway and the user record at the monitoring service via the third interface with the home gateway, after the user record is created at the monitoring service.

The server further includes logic to receive a deactivation request from the computing device via the first interface, or generate a deactivation request when an on-demand monitoring session has expired according to an expiration time. In response to the deactivation request, whether it is received via the first interface or generated according to the expiration time, the logic can determine if the home gateway is online. If the home gateway is online, then the protocol can be executed via the second interface with the monitoring service to deactivate the monitoring service, a signal configuration can be removed via the third interface, where the signal configuration is in the home gateway with alarm details specific to the user record at the monitoring service, and a test interval on the home gateway can be removed via the third interface, where the home gateway pings an alarm receiver at the monitoring service at the test interval. If the home gateway is not online, then an initialization flag can be set via the third interface for removing the signal configuration in the home gateway when the home gateway is online, and optionally for removing the test interval in the home gateway at which the home gateway pings an alarm receiver at the monitoring center when the home gateway is online. If the initialization flag is set, then the server can remove the signal configuration and the test interval in the home gateway via the third interface when the home gateway is online.

The logic to execute the protocol via the second interface to create a user record can include logic to request the monitoring service to provide an empty record identification; logic to create the user record using the empty record identification provided by the monitoring service; logic to receive a site identification for the user record from the monitoring service; and logic to set a dispatch type for the user record having the site identification via the second interface.

The logic to execute the protocol via the second interface to create a user record can include logic to send an address of the home gateway stored in the database to the monitoring service; logic to receive coordinates of the address from the monitoring service; and logic to update the address stored in the database with the coordinates of the address.

The logic to execute the protocol via the second interface to create a user record can include logic to request the monitoring service to provide a list of emergency responders corresponding to the address of the gateway stored in the database; logic to select a primary emergency responder from the list of emergency responders; logic to save the list of emergency responders and the primary emergency responder in the database; and logic to respond to the monitoring service with the primary emergency responder.

The logic to execute the protocol via the second interface to create a user record can include logic to set the permit details for the user record at the monitoring service via the second interface. The logic to execute the protocol via the second interface to create a user record can include logic to set the emergency contact details for the user record at the monitoring service via the second interface. The logic to execute the protocol via the second interface to create a user record can include logic to upload the device configuration data stored in the database to the monitoring service to configure the user record.

The logic to verify a connection between the home gateway and the user record via the third interface can include logic to set a signal configuration in the home gateway with alarm details specific to the user record; logic to set a test interval on the home gateway; logic to request the home gateway to ping an alarm receiver at the monitoring service at the test interval with a test signal having the alarm details specific to the user record; and logic to check whether the home gateway has received a response to the test signal from the monitoring service.

Other aspects and advantages of the present invention can be seen on review of the drawings, the detailed description and the claims, which follow.

### BRIEF DESCRIPTION OF THE DRAWINGS

FIG. 1 illustrates a simplified block diagram of an alarm system in accordance with the present technology.

FIG. 2 illustrates a simplified block diagram of an alarm system in accordance with the present technology, including a more detailed block diagram of a server in the alarm system.

FIG. 3 illustrates sensing devices connected to a home gateway (e.g. 330) in an alarm system, in accordance with the present technology.

FIG. 4 illustrates a simplified block diagram of a home gateway in accordance with the present technology.

FIG. 5A illustrates an example on-demand monitoring user interface.

FIG. 5B illustrates an example diagram for an on-demand monitoring activation sequence.

FIG. 6 illustrates a continuation of the on-demand monitoring activation sequence in FIG. 5B.

FIG. 7 illustrates an example sequence diagram for deactivating a monitoring service.

FIG. 8 illustrates an example sequence diagram for maintaining device configuration data.

FIG. 9 illustrates a flowchart for activating a monitoring service, in accordance with the present technology.

FIG. 10 illustrates a flowchart for deactivating a monitoring service, in accordance with the present technology.

### DETAILED DESCRIPTION

A detailed description of embodiments of the present invention is provided with reference to the Figures. It is to be understood that there is no intention to limit the technology to the specifically disclosed structural embodiments and methods but that the technology may be practiced using other features, elements, methods and embodiments. Preferred embodiments are described to illustrate the present technology, not to limit its scope, which is defined by the claims. Those of ordinary skill in the art will recognize a variety of equivalent variations on the description that follows.

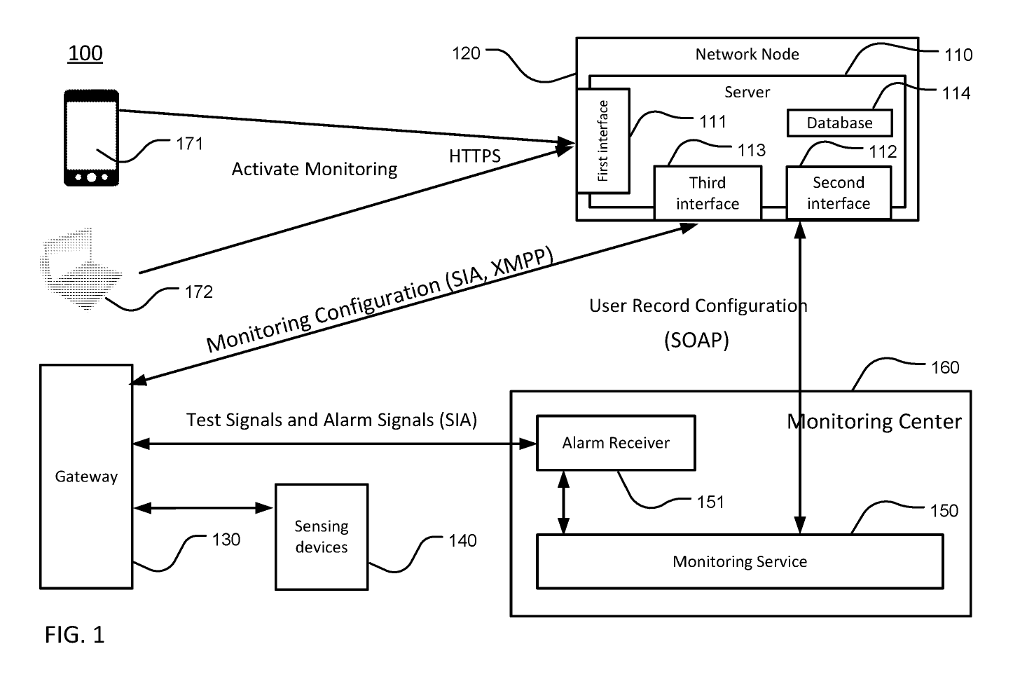

FIG. 1 illustrates a simplified block diagram of an alarm system in accordance with the present technology.

As shown in the example of FIG. 1, a computer program (e.g. 110) is stored in a non-transitory computer readable medium, configured as a server for execution at a network node (e.g. 120) for an alarm system (e.g. 100). The alarm system includes a home gateway (e.g. 130), sensing devices (e.g. 140) connected to the home gateway, and a monitoring service (e.g. 150) connected to an alarm receiver (e.g. 151) at a monitoring center (e.g. 160). An alarm receiver at the monitoring center can convert a test signal or an alarm signal received from a gateway, e.g. an SIA DC-09 signal, into a signal suitable for a monitoring service at the monitoring center. Although in the example of FIG. 1, an alarm receiver at a monitoring center is shown to be associated with one gateway, the alarm receiver can be associated with multiple gateways, for example 10,000 gateways.

As used herein, a physical network node is an active electronic device that is attached to a network, and is capable of sending, receiving, or forwarding information over a communications channel. Examples of electronic devices which can be deployed as network nodes, include all varieties of computers, work stations, laptop computers, hand held computers and smart phones. As used herein, the term “database” does not necessarily imply any unity of structure. For example, two or more separate databases, when considered together, still constitute a “database” as that term is used herein.

The server includes a first interface (e.g. 111) for communication between the network node and a computer device such as a smart phone (e.g. 171) and a laptop computer (e.g. 172), a second interface (e.g. 112) for communication between the network node and the monitoring service, a third interface (e.g. 113) for communication between the network node and the home gateway, and a database (e.g. 114) to store configuration data of the home gateway, including device configuration data indicating the sensing devices connected to the home gateway.

The first interface for communication between the network node and a computer device can use on a communication protocol such as HTTPS (Hypertext Transfer Protocol Secure). HTTPS consists of communication over a communication protocol HTTP (Hypertext Transfer Protocol) within an encrypted connection. HTTP is the foundation of data communication for the world wide web where documents and other web resources can be accessed via the internet. The server can include logic to receive an activation request from the computing device via the first interface and asynchronously with the logic to maintain the configuration data, where the first interface can use on HTTPS for example.

The second interface for communication between the network node and the monitoring service can use a communication protocol such as SOAP (Simple Object Access Protocol). SOAP is a protocol for exchanging structured information in the implementation of web services in computer networks. The server can include logic to, in response to the activation request, execute a protocol, such as the SOAP protocol, via the second interface between the network node and the monitoring service to create a user record at the monitoring service using the configuration data of the home gateway stored in the database. Another example communication protocol the second interface can use is REST (representational state transfer). REST provides interoperability between computer systems on the internet.

The third interface for communication between the network node and the home gateway can use a communication protocol such as the SIA DC-09 standard (Security Industry Association Digital Communication Standard—Internet Protocol Event Reporting) and/or XMPP (Extensible Messaging and Presence Protocol). SIA DC-09 details the protocol and related details to report events from premises equipment to a central station using Internet protocol (IP) to carry the event content. XMPP is a communication protocol for message oriented middleware based on XML (Extensible Markup Language). It enables the near-real-time exchange of structured yet extensible data between any two or more network entities.

The server can include logic to maintain the configuration data in the database via communications using the third interface with the home gateway which include messages identifying sensing devices connected to the home gateway, where the third interface can use the SIA DC-09 standard and/or XMPP for example. The server can include logic to verify a connection between the home gateway and the user record at the monitoring service via the third interface with the home gateway, after the user record is created at the monitoring service, where the third interface can use the SIA DC-09 standard and/or XMPP for example.

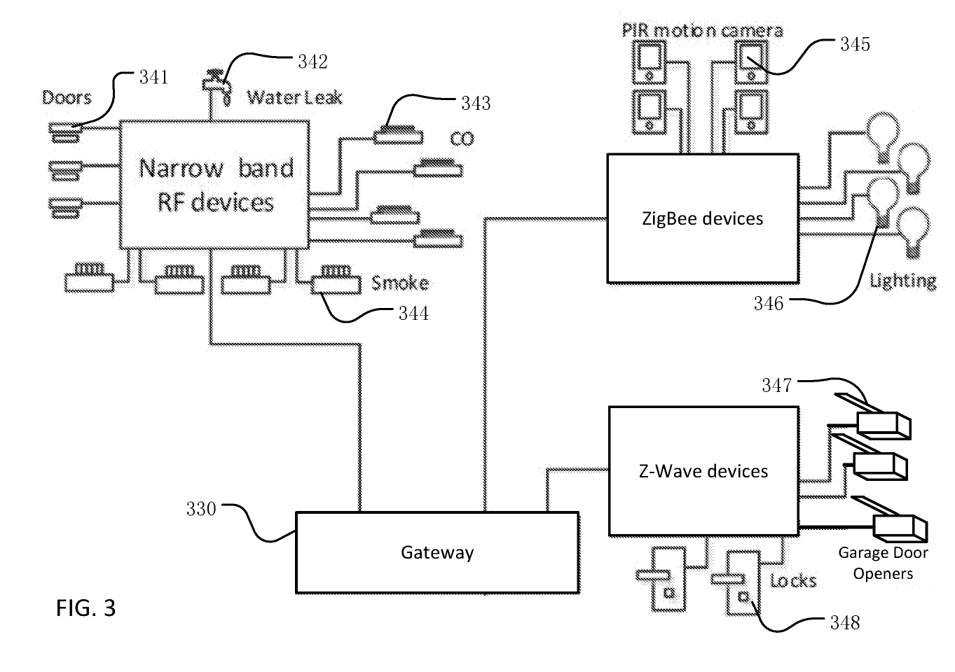

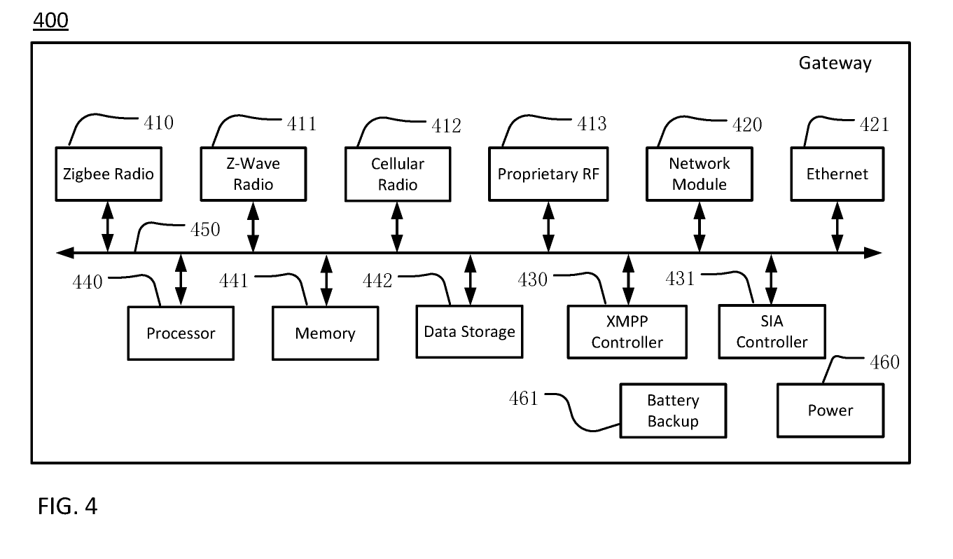

The home gateway (e.g. 130) and sensing devices (e.g. 140) connected to the home gateway are described in connection with FIG. 3 and FIG. 4.

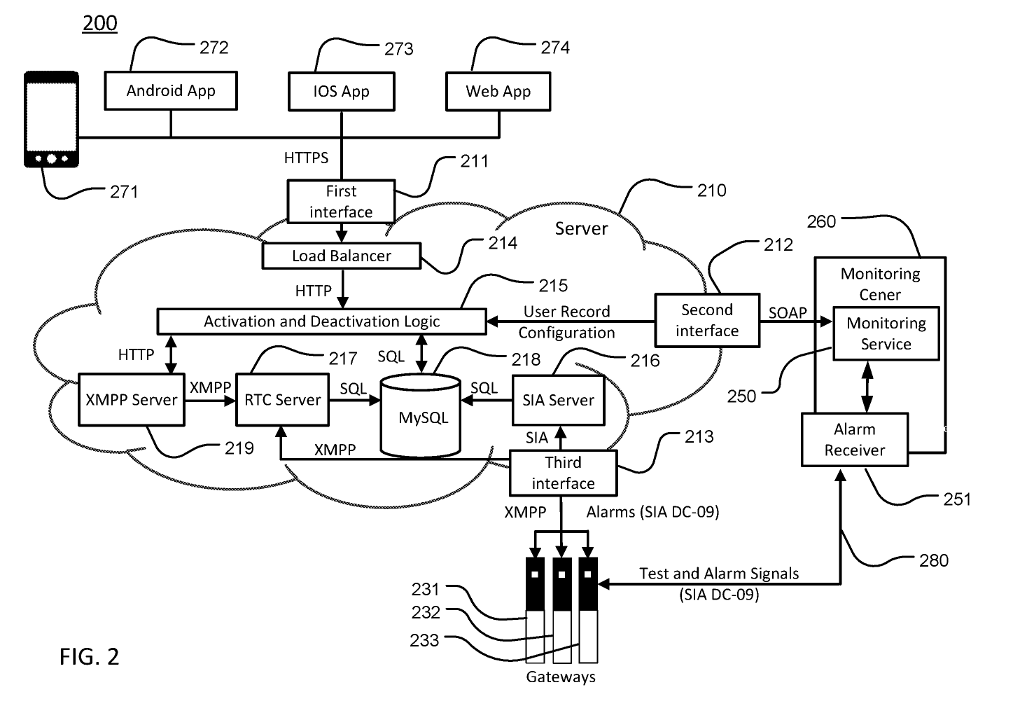

FIG. 2 illustrates a simplified block diagram of an alarm system in accordance with the present technology, including a more detailed block diagram of the server in the alarm system.

As shown in the example of FIG. 2, a computer program (e.g. 210) is stored in a non-transitory computer readable medium, configured as a server for execution at a network node (shown in FIG. 1) for an alarm system (e.g. 200), where the alarm system includes a home gateway (e.g. 231, 232, 233), sensing devices (shown in FIG. 3) connected to the home gateway, and a monitoring service (e.g. 250) connected to an alarm receiver (e.g. 251) at a monitoring center (e.g. 260).

The server includes a first interface (e.g. 211) for communication between the network node and a computer device such as a smart phone (e.g. 271), an Android App (e.g. 272), an IOS App (e.g. 273) and a web App (e.g. 274), a second interface (e.g. 212) for communication between the network node and the monitoring service, a third interface (e.g. 213) for communication between the network node and the home gateway, and a database (e.g. 214) to store configuration data of the home gateway, including device configuration data indicating the sensing devices connected to the home gateway.

Description about the first interface (e.g. 111), the second interface (e.g. 112), and the third interface (e.g. 113) in connection with FIG. 1 is applicable to the first interface (e.g. 211), the second interface (e.g. 212), and the third interface (e.g. 213) shown in FIG. 2, and is not repeated for FIG. 2.

As shown in the example of FIG. 2, the server (e.g. 210) includes a load balancer (e.g. 214) connected to the first interface, activation and deactivation logic (e.g. 215) connected to the second interface, an SIA server (e.g. 216) and an RTC (real time collaboration) server (e.g. 217) connected to the third interface, a database MySQL (e.g. 218) connected to the SIA Server, RTC server, and activation and deactivation logic, and an XMPP server (e.g. 219) connected to the RTC server and activation and deactivation logic.

A load balancer (e.g. 214) is a device that acts as a reverse proxy and distributes network or application traffic across a number of servers. A load balancer is used to increase capacity (concurrent users) and reliability of applications. An example load balancer is the Elastic Load Balancing supported by Amazon Web Services.

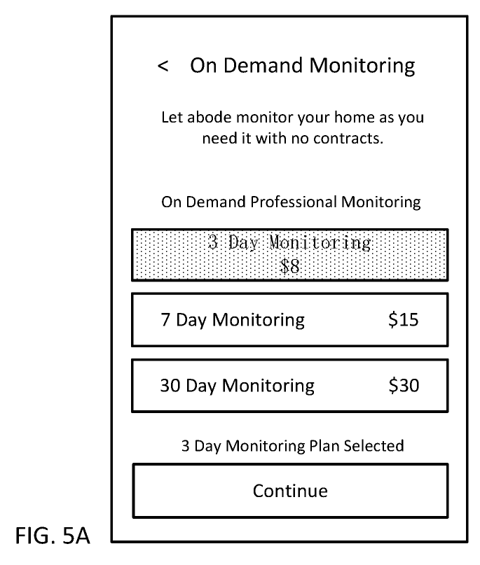

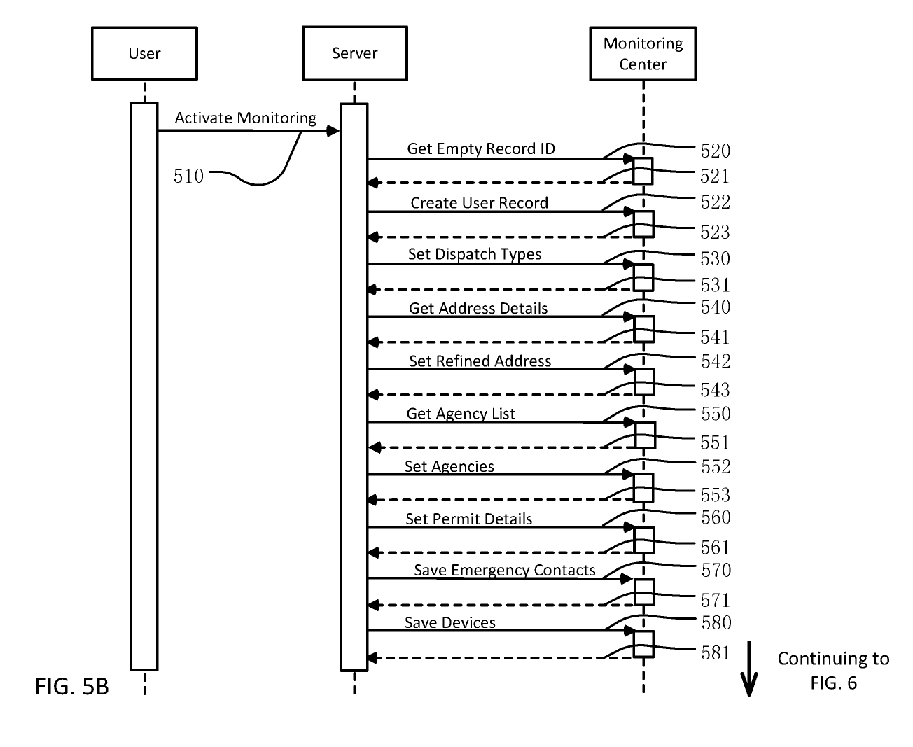

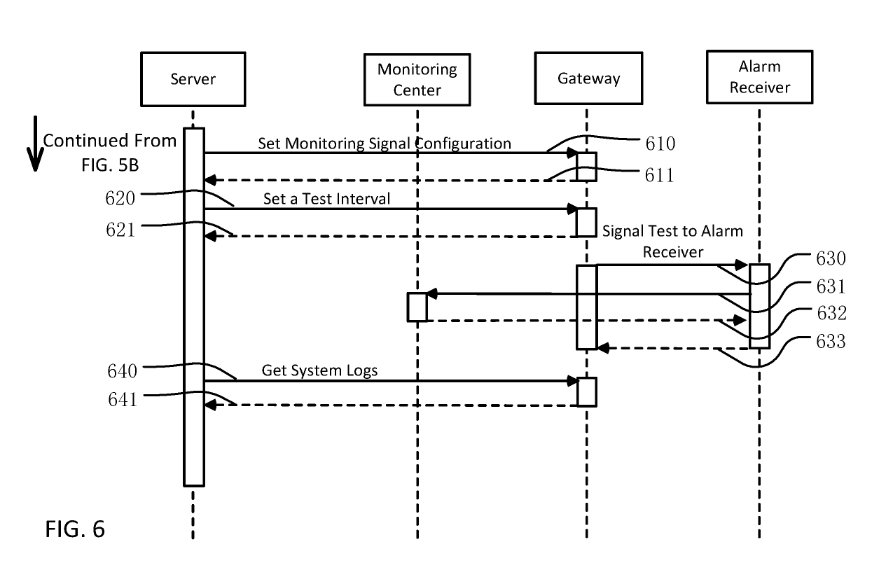

The activation and deactivation logic (e.g. 215) is described in connection with FIG. 5B and FIG. 6.

An SIA server (e.g. 216) receives alarm messages from multiple gateways (e.g. 231, 232, 233), using a communication protocol such as the SIA DC-09 standard, and transmits the alarm messages to database MySQL (e.g. 218). An RTC (real time collaboration) server can be OpenFire licensed under the Open Source Apache License. OpenFire uses a widely adopted open protocol for instant messaging, XMPP (also called Jabber). Openfire provides security and performance. Openfire is used in the present technology to maintain constant connections with all gateways in an alarm system. Using the XMPP communication protocol via a real time collaboration server such as OpenFire, a home gateway and sensing devices connected to the home gateway can be configured, log files on a home gateway can be updated, and a monitoring center can be configured for a monitoring service using a home gateway, and status of sensing devices can be updated.

A database MySQL (e.g. 218) stores configuration data of home gateways in an alarm system, including device configuration data indicating the sensing devices connected to the home gateways via XMPP, and alarm messages received from the home gateways via SIA DC-09.

An XMPP server (e.g. 219) provides messaging service between the activation and deactivation logic (e.g. 215) and the RTC server (e.g. 217), where communication between the XMPP server and the activation and deactivation logic is via the communication protocol HTTP, and communication between the XMPP server and the RTC server (e.g. 217) is via a messaging protocol XMPP.

A connection (e.g. 280) between a home gateway and an alarm receiver (e.g. 251) at a monitoring service (e.g. 250) can use the SIA DC-09 standard for monitoring test signals and alarm signals.

FIG. 3 illustrates sensing devices connected to a home gateway (e.g. 330) in an alarm system, in accordance with the present technology.

In embodiments, sensing devices can be narrow band RF (radio frequency) devices such as door sensors (e.g. 341), water leak sensors (e.g. 342), carbon monoxide sensors (e.g. 343) and smoke sensors (e.g. 344) connected to home gateway (e.g. 330).

In embodiments, sensing devices can be ZigBee devices such as PIR (Passive Infra Red) motion sensing cameras (e.g. 345) and lighting sensors (e.g. 346) connected to home gateway (e.g. 330). ZigBee is an IEEE 802.15.4-based specification for a suite of high-level wireless communication protocols used to create personal area networks with small, low-power digital radios, such as for home automation.

In embodiments, sensing devices can be Z-Wave devices such as garage door openers (e.g. 347) and door lock sensors (e.g. 348) connected to home gateway (e.g. 330). Z-Wave is a wireless communications protocol used primarily for home automation. Z-Wave can provide low-latency transmission of small data packets at data rates up to 100 kbit/s.

FIG. 4 illustrates a simplified block diagram of a home gateway in accordance with the present technology. When on-demand monitoring is activated, the server configures the home gateway with an IP (Internet Protocol) address and account number. This IP/account combination is used for communication to the alarm receiver located in the monitoring center. The communication format between the home gateway and the monitoring center can be, but is not limited to, the SIA DC-09 protocol described herein and/or the Contact ID Alarm Communication Protocol for reporting activity from an alarm system.

As shown in the example of FIG. 4, hardware components in a home gateway (e.g. 400) can include a Zigbee radio board (e.g. 410), a Z-Wave radio board (e.g. 411), a cellular radio board (e.g. 412), and a proprietary RF (radio frequency) board (e.g. 413) for connections with the sensing devices (e.g. 341-348) connected to a home gateway as shown in FIG. 3.

Hardware components in a home gateway can include a network module (e.g. 420), and an Ethernet controller (e.g. 421) connected to the network module, where the Ethernet controller connects the home gateway to the internet. The components can include XMPP controller (e.g. 440) and SIA controller (e.g. 441), for communications with the server for execution at a network node for an alarm system, and for communications with a monitoring service at a monitoring center.

Hardware components in a home gateway can include at least one processor (e.g. 440) including a network node which can communicate with other components in the home gateway via a bus system (e.g. 450), memory (e.g. 441) which can include a number of memories including a main random access memory (RAM) for storage of instructions and data during program execution on the processor and a read only memory (ROM) in which fixed instructions are stored, and data storage (e.g. 442) which can provide persistent storage for program and data files. The components can include power (e.g. 460) and battery backup (e.g. 461).

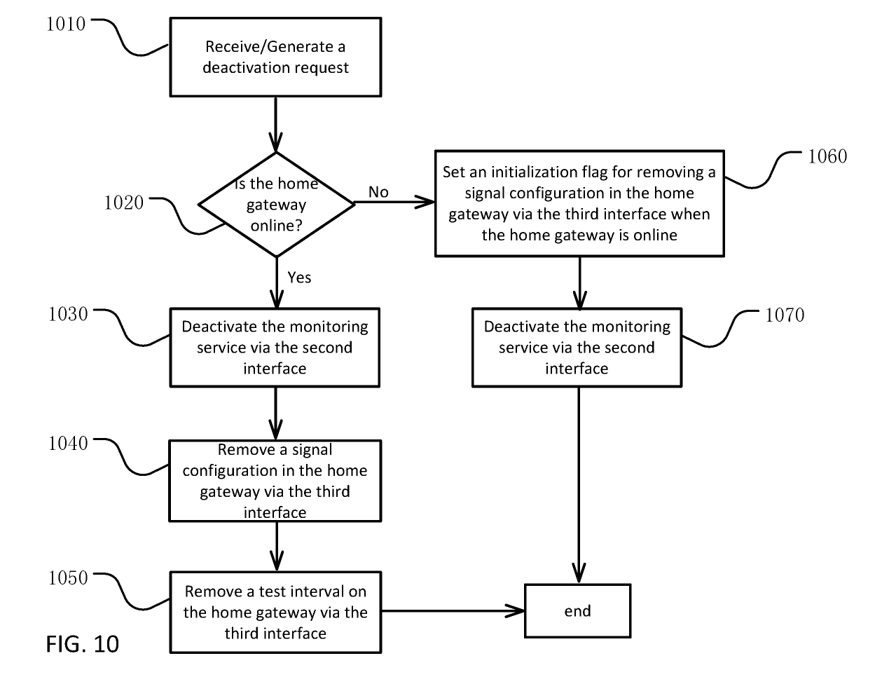

FIG. 5A illustrates an example on-demand monitoring user interface. FIG. 5A illustrates a step during the activation process, when logic on the computing device used by a user of the system presents a graphical user interface, prompting the user to provide input data that is interpreted by the logic as selection of monitoring plans that include activation and deactivation of the monitoring service. By providing input data via this interface, a user can select a monitoring plan (e.g. 3-day, 7-day, or monthly) via the first interface. In this example, the user has selected a 3-day monitoring plan. Once a user selects a plan, the server executes an activation sequence either at the time of the selection, or at a selected time for activation, and sets up an expiration time according to the plan selection, and stores the plan selection and the expiration time in a database (e.g. 218, FIG. 2). When an on-demand monitoring session has expired according to the expiration time, the server generates a deactivation request and starts a deactivation sequence for the on-demand monitoring session as illustrated in FIG. 10.

FIG. 5B illustrates an example diagram for an on-demand monitoring activation sequence. In one example, a user can initiate an activation process for an on-demand monitoring service by using a computer device such as a smart phone (e.g. 271, FIG. 2). Before initiating an activation process, the user sets up his/her gateway, including connecting sensing devices to the gateway, connecting the gateway to the internet, entering a name for himself/herself and optionally names for other family members at the same home, and entering an address of the residence to be monitored, including street number, city, state and zip code. The user can provide information for the activation process through the following example steps:
1. Click on an icon labeled “Tap to protect your home while you are away, enable short term monitoring . . . ” in a user interface (UI) of an application on the computer device for on-demand monitoring.
2. The user is then taken to an on-demand monitoring screen.
3. The user can select a 3-day, 7-day, or monthly monitoring plan (e.g. FIG. 5A).
4. After selecting a plan, the user is required to create a PIN code (Personal Identification Number) which is used to validate their identity in the event of an alarm.
5. The user can create a list of people as emergency contact(s). This is the list of people the monitoring center will call in the event of an alarm.
6. The user can enter his/her credit card information and confirm that the user wants to purchase a plan.
7. Before submitting the credit card information, the user is required to accept the Terms and Agreement for a monitoring service.
8. If the billing transaction and monitoring center connection are successful, an Order Complete Page is sent to the computer device used by the user to request activation of a monitoring service.
9. The user can enter a Permit number if a city requires an alarm permit in order to respond to an alarm event.

The server checks to see if information for residence to be monitored is available, if a home gateway is online, if a PIN code is set, and if the Terms and Agreements has been accepted.

When the user clicks the “Continue” button on the Terms and Agreement page (Step 7 above), the on-demand monitoring activation sequence shown in FIG. 5B begins at Step 510. In other words, before Step 510, using a computer device such as a smart phone (e.g. 271, FIG. 2), a user has entered information for the on-demand monitoring activation sequence. The information that the user has entered is stored in a database (e.g. 218, FIG. 2) in the server (e.g. 210, FIG. 2). Before executing the on-demand monitoring activation sequence shown in FIG. 5B, the monitoring center does not yet have the information the user entered via the computer device. As a result of executing the on-demand monitoring activation sequence shown in FIG. 5B, the server and the monitoring center can have the same information about the user. The information that the user has entered is not stored in the home gateway. The server executes the on-demand monitoring activation sequence in FIG. 5B and FIG. 6. The user is not involved in the execution of the on-demand monitoring activation sequence.

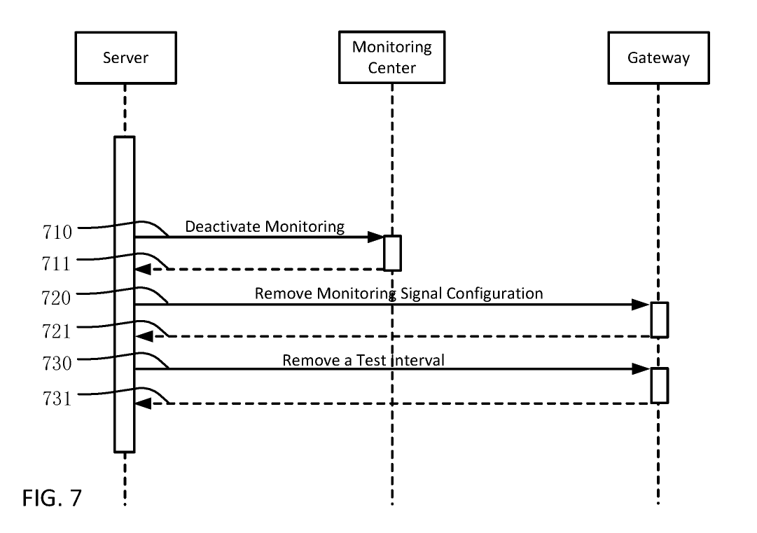

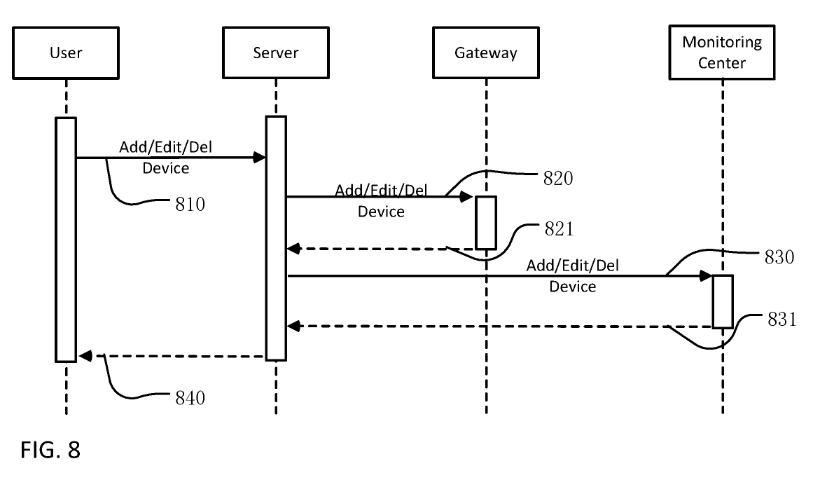

Steps illustrated in FIG. 5B and FIG. 6, as well as in FIG. 7 and FIG. 8, can be implemented with APIs (Application Programming Interface). The procedures and parameters used by the APIs are parts of the server and have complementary components installed at the network node for the monitoring service.

At Step 510, the server receives an activation request from the computer device via the first interface (e.g. 111, FIG. 1; 211, FIG. 2). In response to the activation request, the server executes a protocol via the second interface (e.g. 112, FIG. 2; 212, FIG. 3) to create a user record using the configuration data of the home gateway stored in the database, as explained below with steps illustrated in FIG. 5B.

At Step 520, the server can request the monitoring center to provide an empty record identification. At Step 521, the monitoring center can respond with an empty record identification (e.g. AB0150). At Step 522, the server can request the monitoring center to create a user record with request parameters including the empty record identification. At Step 523, the monitoring center can respond with a site identification for the user record (e.g. “1111”), and the server can receive the site identification. Example request parameters for creating a user record can include user record identification (e.g. “AB0150”), device type (e.g. “Abode”), site name (e.g. first name and last name of a user), site type (e.g. “residential”), street address, city, state, zip code, country, time zone (e.g. “PST”).

At Step 530, the server can set a dispatch type (e.g. “Burglary”) for the user record having the site identification via the second interface. At Step 531, the monitoring center can respond with a message confirming receipt of the dispatch type.

At Step 540, the server can send an address of the home gateway stored in the database to the monitoring center. For instance, the address can include street name, street number, city, state, and zip code (e.g. 94568). At Step 541, the monitoring center can respond with a valid address that includes detailed data needed for emergency responders, including coordinates of the address, zip plus for the zip code (e.g. 94568-48755), fdid (fire department identification number) and mdid (medical department identification number). The server can receive the detailed data for the address from the monitoring center. At Step 542, the server can update the address stored in the database with the detailed data for the address, and set the address with the detailed data at the monitoring center for the user record. At Step 543, the monitoring center can respond with a success message.

At Step 550, the server can request the monitoring center to provide a list of emergency responders corresponding to the address of the gateway stored in the database. At Step 551, in response, the monitoring center can provide the list of emergency responders. For instance, the list of emergency responders can include information such as agency number (e.g. “18569”), agency name (e.g. “Alameda County PD”), agency type (e.g. “police department”), phone number, etc.

At Step 552, the server can select a primary emergency responder from the list of emergency responders; save the list of emergency responders and the primary emergency responder in the database; and respond to the monitoring center with the primary emergency responder. For instance, there could be multiple police departments that could respond to an alarm from a home gateway. When a primary emergency responder is selected and saved at the monitoring center, the monitoring center would know which police department to contact, in response to an alarm triggered by a user's home gateway. At Step 553, the monitoring center can respond with a success message.

At Step 560, the server can set the permit details for the user record at the monitoring service via the second interface, where the permit details have been stored in the database at the server during the on-demand monitoring activation process. For instance, some cities require an alarm permit in order to respond to an alarm event. An alarm permit can include a permit number, a permit starting date, and a permit expiring date, etc. At Step 561, the monitoring center can respond with a success message.

At Step 570, the server can set the emergency contact details for the user record at the monitoring service via the second interface, where the emergency contact details have been stored in the database at the server during the on-demand monitoring activation process. For instance the emergency contact details can include an emergency contact person's first name, last name and phone number. At Step 571, the monitoring center can respond with a success message.

At Step 580, the server can upload the device configuration data stored in the database to the monitoring center to configure the user record at the monitoring center. At Step 581, the monitoring center can respond with a message confirming receipt and storing of the device configuration data.

Up until Step 581, a home gateway is not directly involved in the example sequence for activating a monitoring service, as illustrated in FIG. 5B. The example sequence for activating a monitoring service continues as illustrated in FIG. 6. For steps illustrated in FIG. 6, a home gateway is directly involved.

As shown in the example of FIG. 6, at Step 610, the server can set a signal configuration in the home gateway with alarm details specific to the user record via the third interface. As a parameter, the signal configuration can include a URL (Uniform Resource Locator) for the user record at the monitoring center, so that the home gateway can be configured to send alarm details specific to the user record at the monitoring center. A URL can include an IP address and a protocol (e.g. “SIA”). The signal configuration can include a parameter “group” with an example value “1”, and a parameter “level” with an example value “0”. A home gateway divides signals into different levels such as one level for alarm signals and another level for non-alarm signals. Level configuration in a home gateway decides which type of signals will be sent. Group functionality in a home gateway allows signals to be set to multiple receivers for failover and high availability. When a home gateway is configured for on-demand monitoring, two groups are configured, one group for the monitoring center and the other group for the server. So a same signal can be received by both the monitoring center and the server for further processing. At Step 611, the home gateway can respond with a message confirming receipt of the signal configuration and/or a success in setting the signal configuration.

At Step 620, the server can set a test interval on the home gateway via the third interface, and request the home gateway to ping an alarm receiver at the monitoring center at the test interval with a test signal having the alarm details specific to the user record. The test interval is the interval at which the home gateway can ping an alarm receiver at the monitoring center to make sure the connection is maintained. In other words, the server instructs the home gateway to send a test signal to the alarm receiver on a periodic basis to make sure the connection is maintained. At Step 621, the home gateway can respond with a message confirming receipt of the test interval and/or a success in setting the test interval.

At Step 630, the home gateway sends a test signal to the alarm receiver at the monitoring center. The test signal can include request parameters such as an area and a zone associated with the home gateway. For instance, a house may have only one area (e.g. one floor), or two areas (e.g. one for upstairs and one for downstairs of the house). A zone is associated with a sensing device (e.g. a smoke detector, a lock at the front door, a motion sensor at the back door, a burglar alarm at a window, etc). Sensing devices are connected locally and wirelessly to the home gateway. A home gateway can determine the areas and zones. A user is not aware of the areas and zones associated with a home gateway. At Step 631, the alarm receiver at the monitoring center can convert the test signal received from the home gateway (e.g. an SIA DC-09 signal) into a signal suitable for a monitoring service at the monitoring center. At Step 632, the monitoring center responds to the alarm receiver confirming a success in receiving the test signal. Subsequently at Step 633, the alarm receiver can respond to the home gateway with a message confirming a success in receiving the test signal at the monitoring center. Upon receiving the message, the home gateway can store the message in the home gateway, for example in system logs in the home gateway.

At Step 640, the server can request with request parameters to retrieve the system logs in the home gateway via the third interface between the home gateway and server. For instance, the request parameters can include a parameter “count” with an example value of “10”. This means to check up to 10 last or top log entries in the system logs. At Step 641, the server can receive the log entries from the home gateway, and check whether the home gateway has received a response to the test signal from the monitoring center. If the home gateway has received a response, then the server can activate the monitoring service as requested by the user. Otherwise an error message can be sent to the computer device used by the user to request activation of a monitoring service that the monitoring service was not activated.

FIG. 7 illustrates an example sequence diagram for deactivating a monitoring service. The server can receive a deactivation request from the computing device (e.g. 171, 172, FIG. 1; 271, 272, 273, 274, FIG. 2) via the first interface (e.g. 111, FIG. 1; 211, FIG. 2). Alternatively, when an on-demand monitoring session has expired according to the expiration time, the server can generate a deactivation request. At Step 710, in response to the deactivation request, whether it is received via the first interface or generated according to the expiration time, if the home gateway is online, then the server can execute the protocol (e.g. SOAP) via the second interface (e.g. 112, FIG. 1; 212, FIG. 2) with the monitoring service to deactivate the monitoring service at the monitoring center. At Step 711, the monitoring center can respond with a message confirming success in deactivating the monitoring service.

At Step 720, the server can remove a signal configuration via the third interface (e.g. 113, FIG. 1; 213, FIG. 2) with the home gateway, where the signal configuration is in the home gateway with alarm details specific to the user record at the monitoring service. At Step 721, the monitoring center can respond to the server with a message confirming success in removing the signal configuration.

At Step 730, the server can remove a test interval on the home gateway via the third interface with the home gateway, where the home gateway pings an alarm receiver at the monitoring service at the test interval. At Step 731, the monitoring center can respond to the server with a message confirming success in removing the test interval.

FIG. 8 illustrates an example sequence diagram for maintaining device configuration data. Maintaining device configuration data includes updating the database at the server, the home gateway and the monitoring service at the monitoring center, when a sensing device is added to or deleted from a home gateway and when configuration data about a sensing device is edited.

As a result, the device configuration data is synchronized in the server, the home gateway and the monitoring service, such that any change made by adding, editing or deleting a sensing device in the home gateway is also saved in the server and the monitoring service. Maintaining device configuration data in this way can be done by a user via a computer device such as a smart phone (e.g. 171, FIG. 1) and a laptop computer (e.g. 172, FIG. 1), without a human technician being dispatched to the user's home.

At Step 810, the server receives an add/edit/delete request from the computer device via the first interface (e.g. 111, FIG. 1; 211, FIG. 2). At Step 820, in response to the add/edit/delete request, the server can provide the home gateway with request parameters to update the device configuration data at the home gateway. At Step 821, the home gateway can respond to the server with a message confirming receipt of the request parameters and/or success in updating the device configuration at the home gateway.

At Step 830, the server can execute a protocol (e.g. SOAP) via the second interface (e.g. 112, FIG. 2; 212, FIG. 3) to provide the monitoring center with request parameters to update the device configuration data for the monitoring service at the monitoring center. At Step 831, the monitoring center can respond to the server with a message confirming receipt of the request parameters and/or success in updating the device configuration for the monitoring service at the monitoring center. At Step 840, the server can respond to the computer device from which the server receives the add/edit/delete request, via the first interface with a message confirming success in completing the add/edit/delete request.

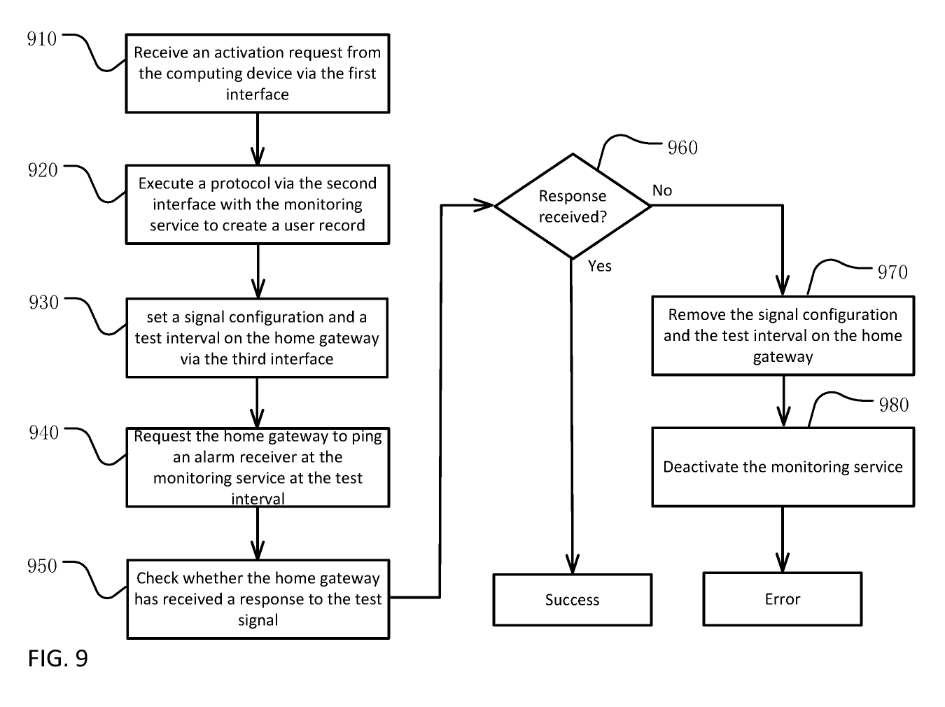

FIG. 9 illustrates a flowchart for activating a monitoring service, in accordance with the present technology. A user is not aware of the steps in the activation process as shown in FIG. 9. At the end of the activation process, a message is sent to a computer device used by a user to request activation of the on-demand monitoring service, confirming success in activating an on-demand monitoring service, or informing if there is an error.

At Step 910, the server can receive an activation request from the computing device via the first interface. At Step 920, in response to the activation request, the server can execute a protocol via the second interface with the monitoring service to create a user record using the configuration data of the home gateway stored in the database. At Step 930, the server can set a signal configuration in the home gateway with alarm details specific to the user record, and set a test interval on the home gateway via the third interface. At Step 940, the server can request the home gateway to ping an alarm receiver at the monitoring service at the test interval with a test signal having the alarm details specific to the user record. At Step 950, the server can check whether the home gateway has received a response to the test signal from the monitoring service. If the home gateway has received a response to the test signal from the monitoring service (Step 960→Yes), then the activation process for a monitoring process is a success. A success message can then be sent to a computer device used by a user to request activation of the on-demand monitoring service via the first interface.

If the home gateway has not received a response to the test signal from the monitoring service (Step 960→No), then at Step 970, the server can remove via the third interface, a signal configuration, where the signal configuration is in the home gateway with alarm details specific to the user record at the monitoring service, and a test interval on the home gateway, where the home gateway pings an alarm receiver at the monitoring service at the test interval. Subsequently at Step 980, the server can execute the protocol via the second interface with the monitoring service to deactivate the monitoring service. Deactivating the monitoring service can include removing the user record at the monitoring service, and/or removing the device configuration data of the home gateway uploaded at the monitoring service for the user record. An error message can then be sent to a computer device used by a user to request activation of the on-demand monitoring service via the first interface.

FIG. 10 illustrates a flowchart for deactivating a monitoring service, in accordance with the present technology. At Step 1010, the server can receive a deactivation request from the computing device via the first interface. Alternatively, when an on-demand monitoring session has expired according to the expiration time, the server can generate a deactivation request. At Step 1020, in response to the deactivation request, whether it is received via the first interface or generated according to the expiration time, the server can determine if the home gateway is online.

If the home gateway is online (Step 1020→Yes), then at Step 1030, the server can execute the protocol via the second interface with the monitoring service to deactivate the monitoring service at the monitoring center. At Step 1040, the server can remove a signal configuration in the home gateway via the third interface, where the signal configuration in the home gateway can have alarm details specific to the user record at the monitoring service. At Step 1050, the server can remove a test interval on the home gateway via the third interface, where the home gateway pings an alarm receiver at the monitoring service at the test interval.

If the home gateway is not online (Step 1020→No), then at Step 1060, the server can set an initialization flag for removing the signal configuration in the home gateway via the third interface when the home gateway is online, and optionally for removing the test interval on the home gateway at which the home gateway pings an alarm receiver at the monitoring center when the home gateway is online. At Step 1070, the server can execute the protocol via the second interface with the monitoring service to deactivate the monitoring service at the monitoring center. If the initialization flag is set, then the server can remove the signal configuration and the test interval in the home gateway via the third interface when the home gateway is online.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A computer program stored in a non-transitory computer readable medium, configured as a server for execution at a network node for an alarm system comprising a home gateway, sensing devices connected to the home gateway, and a monitoring service, the server comprising:
a first interface for communication between the network node and a computer device;
a second interface for communication between the network node and the monitoring service; and
a third interface for communication between the network node and the home gateway; and
a database to store configuration data of the home gateway, including device configuration data indicating the sensing devices connected to the home gateway;
logic to maintain the configuration data in the database via communications using the third interface with the home gateway which include messages identifying sensing devices connected to the home gateway;
logic to receive an activation request from the computing device via the first interface, and in response to the activation request, execute a protocol via the second interface with the monitoring service to create a user record using the configuration data of the home gateway stored in the database; and
logic to verify a connection between the home gateway and the user record at the monitoring service via the third interface with the home gateway, after the user record is created at the monitoring service.

2. The computer program of claim 1, wherein the logic to execute the protocol via the second interface with the monitoring service is initiated asynchronously with the logic to maintain the configuration data.

3. The computer program of claim 1, the server further comprising:
logic to receive input data indicating a request for a monitoring plan via the first interface with the computer device; and
logic to set up an expiration time for the monitoring service according to the monitoring plan.

4. The computer program of claim 1, the server further comprising:
logic to receive a deactivation request from the computing device via the first interface; in response to the deactivation request, determine if the home gateway is online; and
if the home gateway is online, then
execute the protocol via the second interface with the monitoring service to deactivate the monitoring service;
remove, via the third interface, a signal configuration in the home gateway with alarm details specific to the user record at the monitoring service; and
remove, via the third interface, a test interval on the home gateway at which the home gateway pings an alarm receiver at the monitoring service.

5. The computer program of claim 4, said logic to receive a deactivation request further comprising:
if the home gateway is not online, then set an initialization flag for removing the signal configuration in the home gateway via the third interface when the home gateway is online.

6. The computer program of claim 5, the server further comprising:
if the initialization flag is set, logic to remove the signal configuration in the home gateway via the third interface when the home gateway is online.

7. The computer program of claim 1, said logic to execute the protocol via the second interface including
logic to request the monitoring service to provide an empty record identification;
logic to create the user record using the empty record identification provided by the monitoring service; and
logic to receive a site identification for the user record from the monitoring service.

8. The computer program of claim 1, said logic to execute the protocol via the second interface including:
logic to send an address of the home gateway stored in the database to the monitoring service;
logic to receive coordinates of the address from the monitoring service; and
logic to update the address stored in the database with the coordinates of the address.

9. The computer program of claim 1, said logic to execute the protocol via the second interface including:
logic to upload the device configuration data stored in the database to the monitoring service to configure the user record.

10. The computer program of claim 1, said logic to verify the connection between the home gateway and the user record via the third interface including:
logic to set a signal configuration in the home gateway with alarm details specific to the user record;
logic to set a test interval on the home gateway;
logic to request the home gateway to ping an alarm receiver at the monitoring service at the test interval with a test signal having the alarm details specific to the user record; and
logic to check whether the home gateway has received a response to the test signal from the monitoring service.

11. A method for operating an alarm system, for the alarm system a computer program is configured as a server for execution at a network node, the alarm system comprising a home gateway, sensing devices connected to the home gateway, and a monitoring service, the server comprising a first interface for communication between the network node and a computer device, a second interface for communication between the network node and the monitoring service, a third interface for communication between the network node and the home gateway, and a database to store configuration data of the home gateway, including device configuration data indicating the sensing devices connected to the home gateway, the method comprising, using the server:
maintaining configuration data in a database via communications using the third interface with the home gateway which include messages identifying sensing devices connected to the home gateway;
receiving an activation request from the computing device via the first interface, and in response to the activation request, executing a protocol via the second interface with the monitoring service to create a user record using the configuration data of the home gateway stored in the database; and
verifying a connection between the home gateway and the user record at the monitoring service via the third interface with the home gateway, after the user record is created at the monitoring service.

12. The method of claim 11, said executing the protocol via the second interface with the monitoring service is initiated asynchronously with said maintaining the configuration data.

13. The method of claim 11, further comprising:
requesting a monitoring plan via the first interface with the computer device; and
setting up an expiration time for the monitoring service according to the monitoring plan.

14. The method of claim 11, further comprising:
receiving a deactivation request from the computing device via the first interface; in response to the deactivation request, determining if the home gateway is online; and
if the home gateway is online, then
executing the protocol via the second interface with the monitoring service to deactivate the monitoring service;
removing, via the third interface, a signal configuration in the home gateway with alarm details specific to the user record at the monitoring service; and
removing, via the third interface, a test interval on the home gateway at which the home gateway pings an alarm receiver at the monitoring service.

15. The method of claim 14, said receiving a deactivation request further comprising:
if the home gateway is not online, then setting an initialization flag for removing the signal configuration in the home gateway via the third interface when the home gateway is online.

16. The method of claim 15, further comprising:
if the initialization flag is set, removing the signal configuration in the home gateway via the third interface when the home gateway is online.

17. The method of claim 11, said executing the protocol via the second interface including
requesting the monitoring service to provide an empty record identification;
creating the user record using the empty record identification provided by the monitoring service; and
receiving a site identification for the user record from the monitoring service.

18. The method of claim 11, said executing the protocol via the second interface including:
sending an address of the home gateway stored in the database to the monitoring service;
receiving coordinates of the address from the monitoring service; and
updating the address stored in the database with the coordinates of the address.

19. The method of claim 11, said executing the protocol via the second interface including:
uploading the device configuration data stored in the database to the monitoring service to configure the user record.

20. The method of claim 11, said verifying the connection between the home gateway and the user record via the third interface including:
setting a signal configuration in the home gateway with alarm details specific to the user record;
setting a test interval on the home gateway;
requesting the home gateway to ping an alarm receiver at the monitoring service at the test interval with a test signal having the alarm details specific to the user record; and
checking whether the home gateway has received a response to the test signal from the monitoring service.
